(19) United States
(12) Patent Application Publication
(10) Pub. No.: US 2018/0267713 A1
(43) Pub. Date: Sep. 20, 2018

(54) METHOD AND APPARATUS FOR DEFINING STORAGE INFRASTRUCTURE

(71) Applicant: Hitachi, Ltd., Chiyoda ku,Tokyo (JP)

(72) Inventors: Hideo SAITO, Santa Clara, CA (US); Keisuke HATASAKI, Santa Clara, CA (US); Yasutaka KONO, Santa Clara, CA (US); Yukinori SAKASHITA, Santa Clara, CA (US)

(21) Appl. No.: 15/761,798

(22) PCT Filed: Mar. 31, 2016
(86) PCT No.: PCT/US2016/025326

§ 371 Date: Mar. 20, 2018

(51) Int. Cl. G06F 3/06

(52) U.S. Cl. CPC G06F 3/0607; G06F 3/0631; G06F 3/0644; G06F 3/067; G06F 3/065; G06F 3/0647; G06F 3/061; G06F 3/0659

(57) ABSTRACT

Example implementations are directed to systems and methods for how an application defines storage infrastructure. Such example implementations described herein may be used by application programmers to develop applications quickly and flexibly, without having to communicate with storage administrators to make storage infrastructure changes. In an example implementation, there is an application configured to perform storage management operations that change the storage resources allocated to the application.

### FIELD

The present disclosure is directed to storage systems, and more specifically, to storage system and infrastructure management.

### RELATED ART

To develop applications quickly and flexibly, application developers may prefer minimal communication between themselves and infrastructure administrators. In storage infrastructure examples, application developers may prefer having storage infrastructure changes made with minimal communication between themselves and storage administrators.

In related art implementations, there are solutions in which an application can send storage management requests to a storage system, allowing the storage system to be managed without intervention by a storage administrator.

In a related art implementation, there is a system and method to improve data placement optimization. In such related art implementations, an application attaches metadata to a file, and a storage system storing the file optimizes the placement of the file based on the metadata. An example related art implementation to improve data placement operation can be found in PCT Publication No. WO 2014121761 A1, herein incorporated by reference in its entirety for all purposes.

### SUMMARY

Related art solutions only allow an application to manage the storage resources that are allocated to the application. Further, an application cannot change the storage resources allocated to the application. Example implementations described herein are directed to a method and apparatus that allows an application to perform management tasks that involve changing the storage resources allocated to the application. In example implementations, a storage system receives a management request from a host computer, determines the resources required to complete the request, allocates the resources to the host computer, and finally executes the requested management operation.

Aspects of the present disclosure can include a storage system configured to process a command from an application of a host computer directed to a read operation, a write operation or a management operation. The storage system can involve a processor, configured to, for the command being directed to the management operation, determine a first resource allocated to the application; select a second resource managed by the storage system that is not allocated to the application; allocate the second resource to the application; and execute the management operation by using the first resource and the second resource.

Aspects of the present disclosure can include a non-transitory computer readable medium storing instructions for executing a process for a storage system configured to process a command from an application of a host computer directed to a read operation, a write operation or a management operation. The instructions can include, for the command being directed to the management operation, determining a first resource allocated to the application; selecting a second resource managed by the storage system that is not allocated to the application; allocating the second resource to the application; and executing the management operation by using the first resource and the second resource.

Aspects of the present disclosure can include a method for a storage system configured to process a command from an application of a host computer directed to a read operation, a write operation or a management operation. The method can include, for the command being directed to the management operation, determining a first resource allocated to the application; selecting a second resource managed by the storage system that is not allocated to the application; allocating the second resource to the application; and executing the management operation by using the first resource and the second resource.

Aspects of the present disclosure can include a storage system configured to process a command from an application of a host computer directed to a read operation, a write operation or a management operation. The storage system can involve, for the command being directed to the management operation, means for determining a first resource allocated to the application; means for selecting a second resource managed by the storage system that is not allocated to the application; means for allocating the second resource to the application; and means for executing the management operation by using the first resource and the second resource.

### BRIEF DESCRIPTION OF DRAWINGS

FIG. 1 illustrates a physical configuration of a system upon which example implementations may be applied.

FIG. 2 illustrates another example configuration of the system in which example implementations described herein may be applied.

FIG. 3 illustrates an example logical layout of dynamic random access memory (DRAM) for a host computer, in accordance with an example implementation.

FIG. 4 illustrates an example logical layout of DRAM for a primary storage system, in accordance with an example implementation.

FIG. 5 illustrates a logical layout of DRAM for the management computer, in accordance with an example implementation.

FIG. 6 illustrates a logical layout of a storage pool management table, in accordance with an example implementation.

FIG. 7 illustrates a logical layout of the volume management table, in accordance with an example implementation.

FIG. 8 illustrates a logical layout of a remote replication path management table, in accordance with an example implementation.

FIG. 9 illustrates a logical layout of a remote replication pair management table, in accordance with an example implementation.

FIG. 10 illustrates a logical layout of the local replication pair management table, in accordance with an example implementation.

FIG. 11 illustrates a flow chart for command processing, in accordance with an example implementation.

FIG. 12 illustrates a flow chart for management request processing, in accordance with an example implementation.

FIG. 13 illustrates a logical layout of the DRAM of a primary storage system, in accordance with an example implementation.

FIG. 14 illustrates a logical layout of a storage functionality management table, in accordance with an example implementation.

FIG. 15 illustrates a flow diagram for management request processing, in accordance with an example implementation.

FIG. 16 illustrates a logical layout of DRAM for a primary storage system, in accordance with an example implementation.

FIG. 17 illustrates a logical layout of a volume management table, in accordance with an example implementation.

FIG. 18 illustrates a logical layout of a CPU Utilization Management Table, in accordance with an example implementation.

FIG. 19 illustrates a flow diagram for management request processing, in accordance with an example implementation.

### DETAILED DESCRIPTION

The following detailed description provides further details of the figures and example implementations of the present application. Reference numerals and descriptions of redundant elements between figures are omitted for clarity. Terms used throughout the description are provided as examples and are not intended to be limiting. For example, the use of the term “automatic” may involve fully automatic or semi-automatic implementations involving user or administrator control over certain aspects of the implementation, depending on the desired implementation of one of ordinary skill in the art practicing implementations of the present application.

Example implementations can involve a system in which an application can perform storage management operations that change the resources allocated to the application (e.g., add a Solid State Drive (SSD) to a thin provisioning pool associated with the Logical Unit (LU) allocated to the application). Example implementations involve a system in which an application designates a high-level objective (e.g., facilitate disaster recovery), and a storage system selects the optimal storage function from among the implemented storage functions (e.g., synchronous remote replication) to meet the objective.

Example implementations can further involve a system in which an application designates an objective (e.g., reduce input/output (I/O) response time) along with a storage management request (e.g, add an SSD to a thin provisioning pool), wherein the storage system determines if the objective can be met by the request.

In a first example implementation, there is an application configured to perform storage management operations that change the storage resources allocated to the application.

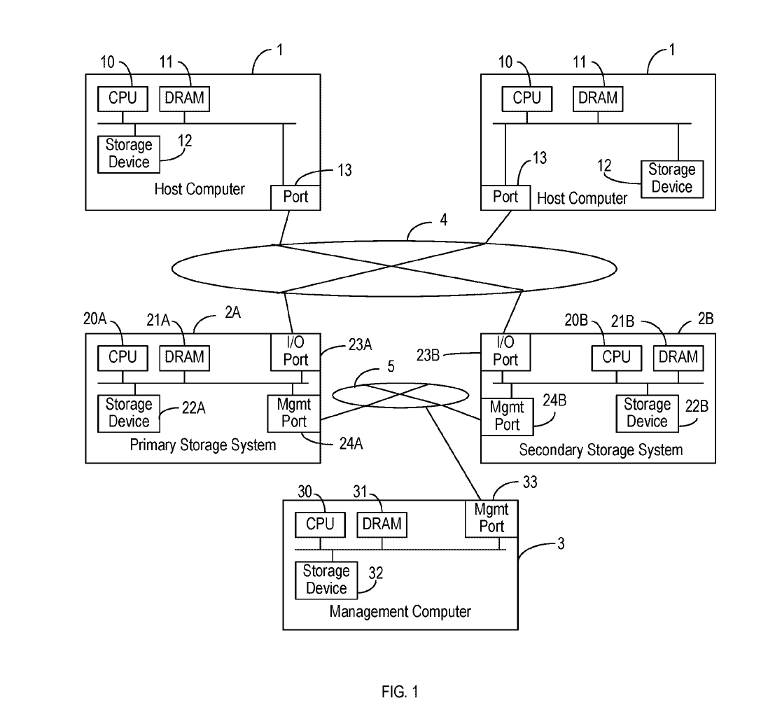

FIG. 1 illustrates a physical configuration of a system upon which example implementations may be applied. In the example implementation of FIG. 1, one or more Host Computers 1, a Primary Storage System 2A and one or more Secondary Storage Systems 2B are connected to each other via a storage area network (SAN) 4. Primary Storage System 2A, Secondary Storage Systems 2B and a Management Computer 3 are connected to each other via a local area network (LAN) 5.

Host Computer 1 can involve one or more central processing units (CPUs) 10 that involve one or more physical processors, Dynamic Random Access Memory (DRAM) 11, one or more Storage Devices 12 and one or more Ports 13. CPU 10 is configured to execute one or more application programs stored in Storage Device 12, using DRAM 11 as working memory. Port 13 connects Host Computer 1 to SAN 4.

Primary Storage System 2A can include one or more CPUs 20A, DRAM 21A, one or more Storage Devices 22A, one or more I/O Ports 23A and one or more Management Ports 24A. CPU 20A can be configured to execute storage software using a part of DRAM 21A as working memory. Storage Device 22A may be a hard disk drive (HDD), an SSD or any other permanent storage device. I/O Port 23A connects Primary Storage System 2A to SAN 4, and Management Port 24A connects Primary Storage System 2A to LAN 5.

Secondary Storage System 2B can include of one or more CPUs 20B, DRAM 21B, one or more Storage Devices 22B, one or more I/O Ports 23B and one or more Management Ports 24B. CPU 20B is configured to execute storage software using a part of DRAM 21B as working memory. Storage Device 22B may be a HDD, an SSD or any other non-volatile storage device. I/O Port 23B connects Secondary Storage System 2B to SAN 4, and Management Port 24B connects Secondary Storage System 2B to LAN 5.

Host Computer 1 sends I/O requests to Primary Storage System 2A. I/O requests include read requests and write requests. Primary Storage System 2A processes a read request by reading data from Storage Device 22A and sending the data to Host Computer 1. Primary Storage System 2A processes a write request by receiving data from Host Computer 1 and writing the data to Storage Device 22A. Primary Storage System 2A may use a part of DRAM 21A as cache memory to temporarily store read or write data. Primary Storage System 2A possesses functionality to replicate data to a Secondary Storage System 2B. This allows a Secondary Storage System 2B to be used as a secondary system in a disaster recovery configuration or to be used to store remote backups.

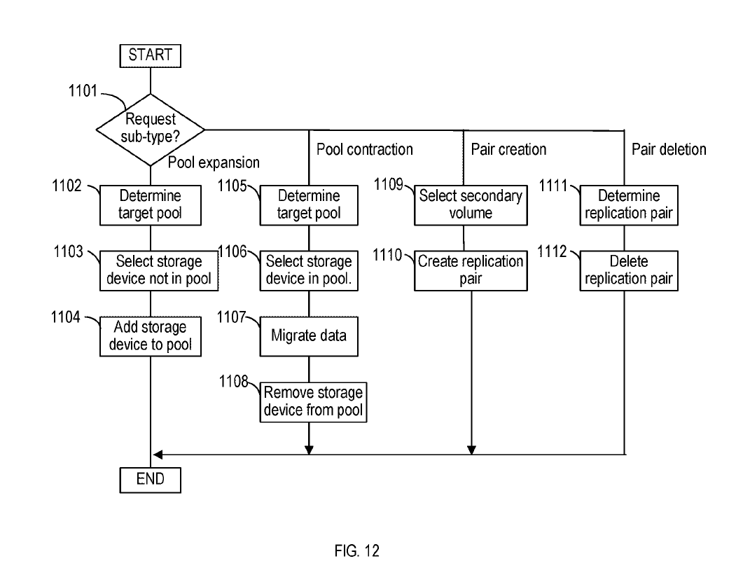

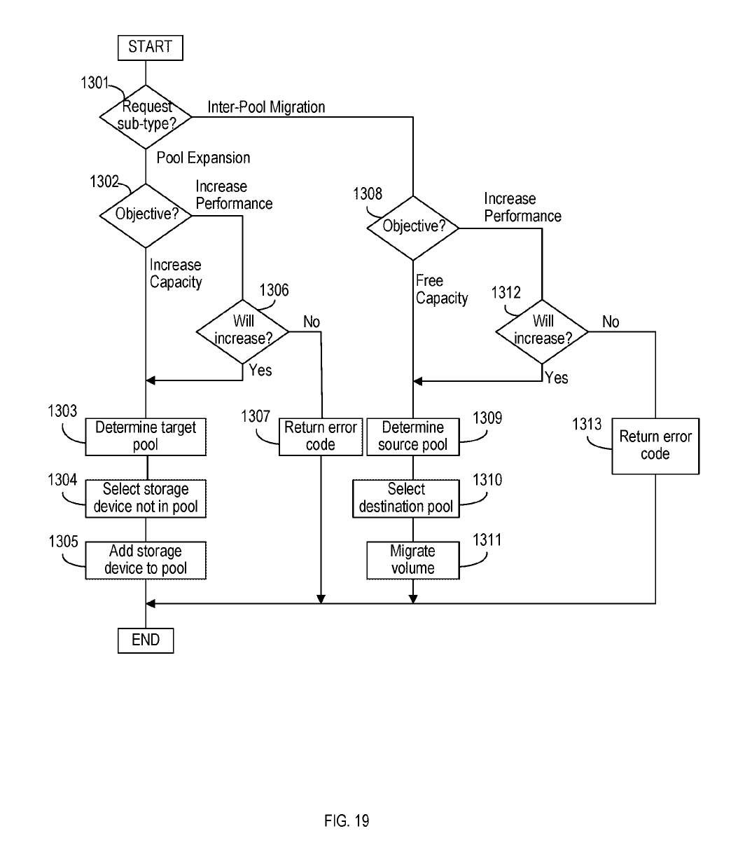

Host Computer 1 and Management Computer 3 send management requests to Primary Storage System 2A. Management requests include storage pool management requests, replication pair management requests, disaster recovery management requests, and backup management requests. For the command received by the Primary Storage System 2A being directed to such a management operation, Primary Storage System 2A can be configured to, through use of any combination of CPU 20A, DRAM 21A and Storage Device 22A, determine a first resource allocated to the application of the Host Computer 1 or Management Computer 3; select a second resource managed by the storage system that is not allocated to the application; allocate the second resource to the application; and execute the management operation by using the first resource and the second resource as described herein. For example, when the management operation is directed to a storage pool expansion request, the Primary Storage System 2A can be configured to determine the first resource allocated to the application through a determination of a target storage pool that is allocated to the application; select the second resource through a selection of a storage device that is not allocated to the target storage pool; and execute the management operation through an allocation of the storage device to the target storage pool as described in FIG. 12. If such a management operation is directed to an objective to increase performance, Primary Storage System 2A is configured to process the command only for a determination that the objective to increase performance is met as described in FIG. 19.

In an example of the management operation being directed to a replication pair creation request, Primary Storage System 2A can be configured to determine the first resource allocated to the application through a determination of a first volume that is allocated to the application; select the second resource through a selection of a second volume that is not allocated to the application; and execute the management operation through a creation of a replication pair between the first volume and the second volume as described in FIG. 12.

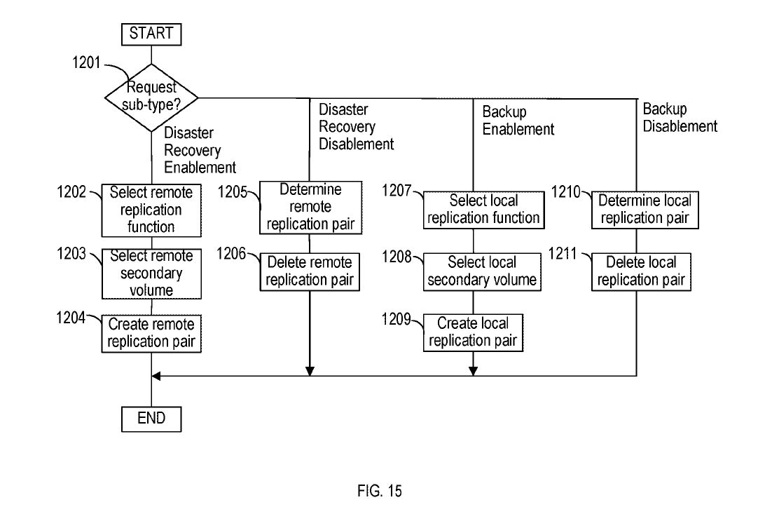

In an example of the management operation being directed to a disaster recovery enablement request, Primary Storage System 2A can be configured to select a remote replication storage function; determine the first resource allocated to the application through a determination of a first volume that is allocated to the application; select the second resource through a selection of a second volume that is not allocated to the application, wherein the second volume is located remotely from the storage system; and execute the management operation through a creation of a replication pair between the first volume and the second volume and through a provision of the remote replication storage function to the application as described in FIG. 15.

In an example of the management operation being directed to a backup enablement request, Primary Storage System 2A can be configured to select a local replication storage function; determine the first resource allocated to the application through a determination of a first volume that is allocated to the application; select the second resource through a selection of a second volume that is not allocated to the application and that is provisioned locally within the storage system; and execute the management operation through a creation of a replication pair between the first volume and the second volume and through a provision of the local replication storage function to the application as described in FIG. 15.

In an example of the management operation being directed to an inter-pool migration, Primary Storage System 2A can be configured to determine the first resource allocated to the application through a determination of a first volume that is allocated to the application. Further, Primary Storage system 2A can be configured to select the second resource through a selection of a second volume that is not allocated to the application; and execute the management operation through a migration of the first volume to the second volume. Further detail is provided in FIG. 19.

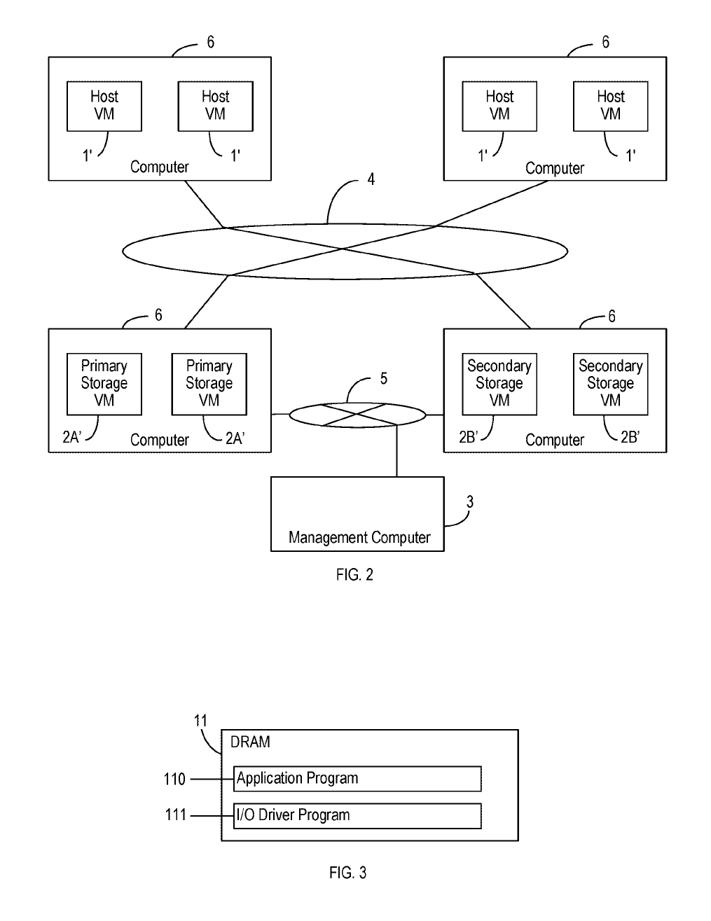

FIG. 2 illustrates another example configuration of the system in which example implementations described herein may be applied. One or more Computers 6 are communicatively connected to each other via SAN 4. Computers 6 and Management Computer 3 are connected to each other via LAN 5. Computer 6 has the same configuration as Host Computer 1 in FIG. 1. One or more of Computers 6 executes one or more Host Virtual Machines (VMs) 1′. Host VM 1′ is a virtual machine that uses a part of the resources of Computer 6 to execute programs. Host VM 1′ logically functions the same way as Host Computer 1 in FIG. 1.

One or more Computers 6 executes one or more Primary Storage VMs 2A′. Primary Storage VM 2A′ is a virtual machine that uses a part of the resources of Computer 6 to execute programs. Primary Storage VM 2A′ logically functions the same way as Primary Storage System 2A in FIG. 1. If there are multiple Primary Storage VMs 2A′, the multiple Primary Storage VMs 2A′ collectively have the same function as Primary Storage System 2A in FIG. 1.

One or more Computers 6 executes one or more Secondary Storage VMs 2B′. Secondary Storage VM 2B′ is a virtual machine that uses a part of the resources of Computer 6 to execute programs. Secondary Storage VM 2B′ logically functions the same way as Secondary Storage System 2B in FIG. 1. If there are multiple Secondary Storage VMs 2B′, the multiple Secondary Storage VMs 2B′ collectively have the same function as Secondary Storage System 2B in FIG. 1. One or more Host VMs 1′ may run on the same Computer 6 as one or more Primary Storage VMs 2A′. Further, one or most Host VMs 1′ may run on the same Computer 6 as one or more Secondary Storage VMs 2B′.

FIG. 3 illustrates a logical layout of DRAM for a host computer, in accordance with an example implementation. Specifically, FIG. 3 illustrates the logical layout of DRAM 11, which can include Application Program 110 and I/O Driver Program 111. Application Program 110 uses an Application Programming Interface (API) provided by I/O Driver Program 111 to instruct I/O Driver Program 111 to create and send management requests to Primary Storage System 2A. Alternatively, Application Program 110 creates management requests and passes them to I/O Driver Program 111. I/O Driver Program 111 then sends the requests to Primary Storage system 2A unmodified.

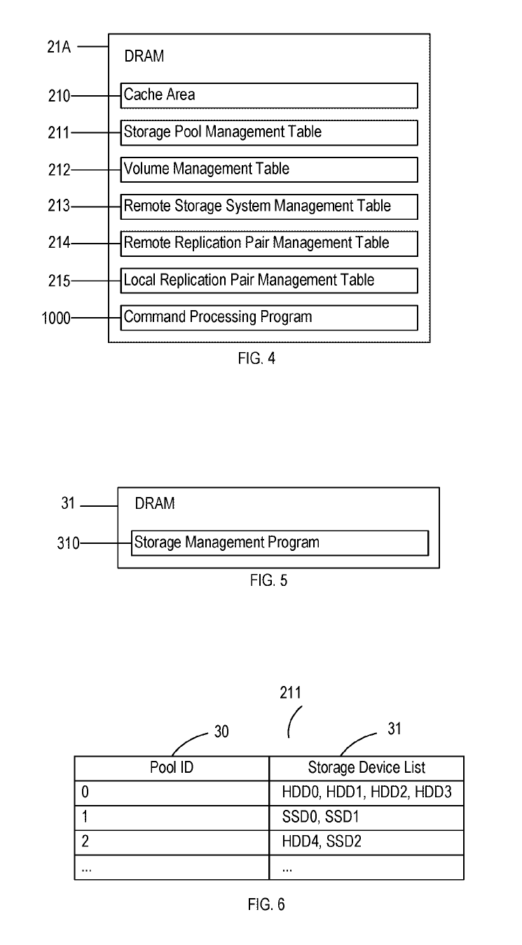

FIG. 4 illustrates an example logical layout of DRAM for a primary storage system, in accordance with an example implementation. FIG. 4 illustrates the logical layout of DRAM 21A, which can include Cache Area 210, Storage Pool Management Table 211, Volume Management Table 212, Remote Replication Path Management Table 213, Remote Replication Pair Management Table 214, Local Replication Pair Management Table 215 and Command Processing Program 1000.

Command Processing Program 1000 is executed by CPU 20A when Primary Storage System 2A receives an I/O request or a management request from Host Computer 1. Command Processing Program 1000 uses Storage Pool Management Table 211, Volume Management Table 212, Remote Storage System Management Table 213, Remote Replication Pair Management Table 214 and/or Local Replication Pair Management Table 215 in order to process the I/O request or the management request. In the case that Primary Storage system 2A receives an I/O request from Host Computer 1, Command Processing Program 1000 uses Cache Area 210 to temporarily store read or write data. The logical layout of DRAM 21B can be the same as that of DRAM 21A, except each area, table or program is used to control Secondary Storage System 2B instead of Primary Storage System 2A.

FIG. 5 illustrates a logical layout of DRAM for the management computer, in accordance with an example implementation. Specifically, FIG. 5 illustrates the logical layout of DRAM 31, which can include Storage Management Program 310. Storage Management Program 310 sends management requests to Primary Storage System 2A. The management requests sent by Application Program 110 are sent via SAN 4 and addressed to a volume allocated to Application Program 110. Meanwhile, the management requests sent by Management Program 310 are sent via LAN 5 and addressed to Primary Storage System 2A.

FIG. 6 illustrates a logical layout of a storage pool management table, in accordance with an example implementation. Specifically, FIG. 6 illustrates the logical layout of Storage Pool Management Table 211, which is used to manage the storage pools from which volumes are provisioned. Storage Pool Management Table 211 can include multiple entries, each corresponding to a storage pool. Each entry can include Pool identifier (ID) 2110 and Storage Device List 2111. Pool ID 2110 is used to identify a storage pool internally within Primary Storage System 2A. Example values of Pool ID 2110 are “0”, “1” and “2”. Storage Device List 2111 is a list of the Storage Devices 22A included in the storage pool identified by Pool ID 2110. Storage Device List 2111 can contain IDs of HDDs, SSDs, other permanent storage devices or a combination of different storage devices. Instead of being a list of Storage Devices 22A, Storage Device List 2111 can be a list of Redundant Array of Inexpensive Disk (RAID) groups. A RAID group is a group of Storage Devices 22A that protects data using a redundancy mechanism such as RAID-1, RAID-5 or RAID-6.

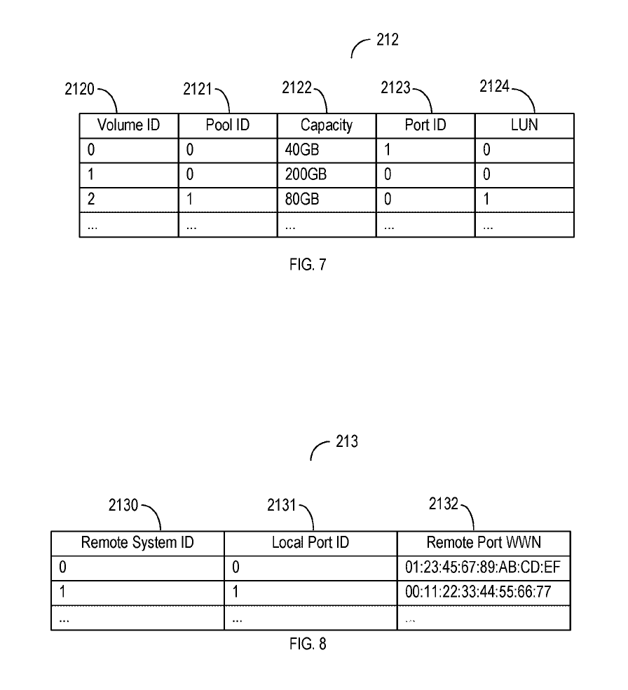

FIG. 7 illustrates a logical layout of the volume management table, in accordance with an example implementation. Specifically, FIG. 7 illustrates the logical layout of Volume Management Table 212, which is used to manage the volumes created from storage pools and allocated to Host Computers 1. Volume Management Table 212 can include of multiple entries, each of which can correspond to a volume. Each entry can include of Volume ID 2120, Pool ID 2121, Capacity 2122, Port ID 2123 and Logical Unit Number (LUN) 2124. Volume ID 2120 is used to identify a volume internally within Primary Storage System 2A. Example values of Volume ID 2120 are “0”, “1” and “2”. Pool ID 2121 is used to identify the pool from which the volume identified by Volume ID 2120 is provisioned. Pool ID 2121 corresponds to Pool ID 2110 in Storage Pool Management Table 211. Capacity 2122 is the capacity of the volume identified by Volume ID 2120. Example values of Capacity 2122 are “40 GB”, “80 GB” and “200 GB”. Port ID 2123 is used to identify the I/O Port 23 through which the volume identified by Volume ID 2120 can be accessed. Example values of Port ID 2123 are “0” and “1”. LUN 2124 is the Logical Unit Number used to address this volume. Host Computer 1 includes a Logical Unit Number in each I/O request or management request that it sends to Primary Storage System 2A in order to specify the target volume of the request. A volume can be uniquely identified by the combination of the I/O Port 23 to which the request is sent and the Logical Unit Number included in the request. Example values of LUN 2124 are “0” and “1”.

FIG. 8 illustrates a logical layout of a remote replication path management table, in accordance with an example implementation. Specifically, FIG. 8 illustrates the logical layout of Remote Storage System Management Table 213. Remote Storage System Management Table 213 is used to manage the Secondary Storage Systems 2B to which data is remotely replicated from Primary Storage System 2A. Remote Storage System Management Table 213 can include multiple entries, each which can correspond to a Secondary Storage System 2B. Each entry can include of Remote System ID 2130, Local Port ID 2131 and Remote Port World Wide Name (WWN) 2132. Remote System ID 2130 is used to identify a Secondary Storage System 2B internally within Primary Storage System 2A. Example values of Remote System ID are “0” and “1”. Local Port ID 2131 is used to identify the I/O Port 23A through which Primary Storage System 2A is connected to the Secondary Storage System 2B identified by Remote System ID 2130. Example values of Local Port ID 2131 are “0” and “1”. Remote Port WWN 2132 is used to identify the I/O Port 23B through which Secondary Storage System 2B is connected to Primary Storage System 2A. Example values of Remote Port WWN 2132 are “01:23:45:67:89:AB:CD:EF” and “00:11:22:33:44:55:66:77”.

FIG. 9 illustrates a logical layout of a remote replication pair management table, in accordance with an example implementation. Specifically, FIG. 9 illustrates the logical layout of Remote Replication Pair Management Table 214, which is used to manage remote replication volume pairs. Remote Replication Pair Management Table 214 can include multiple entries, each of which correspond to a remote replication volume pair. Each entry can include Pair ID 2140, Remote System ID 2141, Primary Volume ID 2142 and Secondary Volume ID 2143. Pair ID 2140 is used to identify a remote replication volume pair internally within Primary Storage System 2A. Example values of Pair ID 2140 are “0”, “1” and “2”. Remote System ID 2141 is used to identify the Secondary Storage System 2B providing the volume acting as the destination of the remote replication. Remote System ID 2141 corresponds to Remote System ID 2130 in Remote Storage System Management Table 213. Primary Volume ID 2142 is used to identify the volume inside Primary Storage System 2A acting as the source of the remote replication. Primary Volume ID 2142 corresponds to Volume ID 2120 in Volume Management Table 212. Secondary Volume ID 2143 is used to identify the volume inside Secondary Storage System 2B acting as the destination of the remote replication.

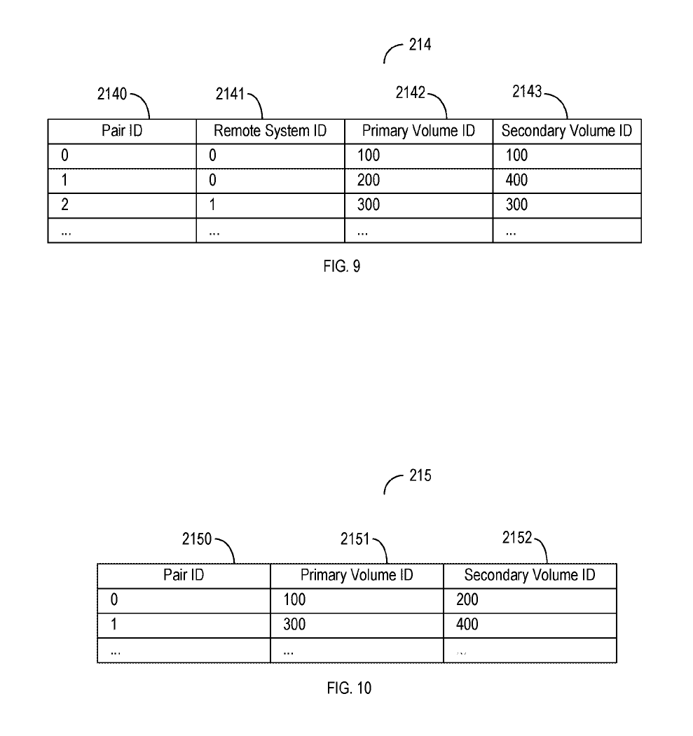

FIG. 10 illustrates a logical layout of the local replication pair management table, in accordance with an example implementation. Specifically, FIG. 10 illustrates the logical layout of the Local Replication Pair Management Table 215, which is used to manage local replication volume pairs. Local Replication Pair Management Table 215 can include multiple entries, each of which correspond to a local replication volume pair. Each entry can include Pair ID 2150, Primary Volume ID 2151 and Secondary Volume ID 2152. Pair ID 2150 is used to identify a local replication volume pair internally within Primary Storage System 2A. Example values of Pair ID are “0” and “1”. Primary Volume ID 2151 is used to identify the volume inside Primary Storage System 2A acting as the source of the local replication. Primary Volume ID 2151 corresponds to Volume ID 2120 in Volume Management Table 212. Secondary Volume ID 2152 is used to identify the volume inside Primary Storage System 2A acting as the destination of the local replication. Secondary Volume ID 2152 corresponds to Volume ID 2120 in Volume Management Table 212.

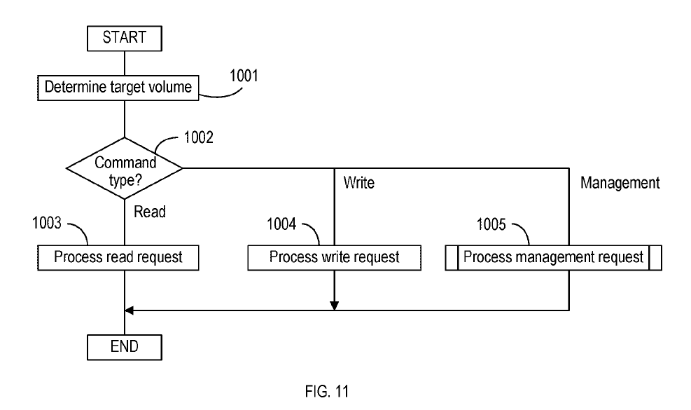

FIG. 11 illustrates a flow chart for command processing, in accordance with an example implementation. The flow of FIG. 11 can be executed by Command Processing Program 1000 on CPU 20A when Primary Storage System 2A receives a command from Host Computer 1. The received command contains a Logical Unit Number used to address a particular volume inside Primary Storage System 2A. The received command also contains an operation code and an operation sub-code that specifies the operation requested by the command.

At 1001, the Command Processing Program 1000 determines the target volume of the received command by extracting the Logical Unit Number from the command and referencing the LUN in Volume Management Table 212. At 1002, the Command Processing Program 1000 determines whether the type of the received command is a read request, a write request or a management request by extracting the operation code from the command. If the command type is a read request (Read), then the flow proceeds to 1003, wherein the Command Processing Program 1000 processes the read request. Command Processing Program 1000 reads data from Storage Device 22A and sends the data to Host Computer 1. If the command type is a write request (Write), then the flow proceeds to 1004, wherein the Command Processing Program 1000 processes the write request. Command Processing Program 1000 receives data from Host Computer 1 and writes the data to Storage Device 22A. If the command type is a management request (Management), then the flow proceeds to 1005, wherein the Command Processing Program 1000 processes the management request. Details of the management request are described in FIG. 12.

FIG. 12 illustrates a flow chart for management request processing, in accordance with an example implementation. Specifically, FIG. 12 shows the flow chart of management request processing that corresponds to the flow of 1005 of FIG. 11. At 1101, the Command Processing Program 1000 determines whether the sub-type of the management request is a storage pool expansion request, a storage pool contraction request, a replication pair creation request or a replication pair deletion request by extracting the operation sub-code from the received command.

For the sub-type of the management request being a storage pool expansion request (Pool expansion), the flow proceeds to 1102 wherein the Command Processing Program 1000 determines the target storage pool of the storage pool management request. To make this determination, Command Processing Program 1000 references Volume Management Table 212 and locates the entry whose Volume ID 2120 is equal to the ID of the volume determined in Step 1001. Pool ID 2121 of the located entry is the ID of the target storage pool. The flow proceeds to 1103, wherein the Command Processing Program 1000 selects from Storage Devices 22A in Primary Storage System 2A a Storage Device 22A that is not being used by any storage pool. At 1104, the Command Processing Program 1000 adds the Storage Device 22A selected in Step 1103 to the target storage pool by updating Storage Pool Management Table 211.

For the sub-type of the management request being a storage pool contraction request, the flow proceeds to 1105, wherein the Command Processing Program 1000 proceeds in the similar way to 1102 to determine the target storage pool. The flow proceeds to 1106 wherein the Command Processing Program 1000 selects a Storage Device 22A that is being used by the target storage pool by referencing Storage Pool Management Table 211. At 1107, the Command Processing Program 1000 migrates the data stored on the Storage Device 22A selected in the flow at 1106 to a different Storage Device 22A that is being used by the target storage pool. At 1108, the Command Processing Program 1000 removes the Storage Device 22A selected in the flow at 1106 from the target storage pool by updating Storage Pool Management Table 211.

For the sub-type of the management request being a replication pair creation request, the flow proceeds to 1109, wherein the Command Processing Program 1000 selects a volume to be used as the destination of remote replication by selecting a Secondary Storage System 2B from Remote Storage System Management Table 213 and querying it. The Secondary Storage System 2B that receives the query responds to the query with the ID of an unused volume of Secondary Storage System 2B.

The Command Processing Program 1000 may specify the capacity of the volume to be used as the destination of remote replication in the query to Remote Storage System 2B. In this case, the Secondary Storage System 2B that receives the query responds to the query with the ID of an unused volume of Secondary Storage System 2B that has the same or larger capacity as the capacity specified in the query. The capacity that Command Processing Program 1000 specifies is the same as the volume to be used as the source of remote replication, which is the volume determined from the flow at 1001. Command Processing Program 1000 determines the capacity of the volume determined in the flow at 1001 by referencing Volume Management Table 212.

If the Secondary System 2B that receives the query cannot find an unused volume, it responds to the query with an error code. Upon receiving the error code, Command Processing Program 1000 selects a different Secondary Storage System 2B from Remote Storage System Management Table 213 and queries it. This process is repeated until a volume to be used as the destination of remote replication is found. Alternatively, if the Secondary System 2B that receives the query cannot find an unused volume, the Secondary System 2B may create a new volume and respond to the query with the ID of the new volume.

The flow then proceeds to 1110, wherein the Command Processing Program 1000 creates a remote replication pair between the volume determined in the flow at 1001 and the volume selected in the flow at 1109 by adding a new entry to Remote Replication Pair Management Table 214.

For the sub-type of the management request being a replication pair deletion request, the flow proceeds to 1111, wherein the Command Processing Program 1000 determines the target remote replication pair by looking up Remote Replication Pair Management Table 214 and locating the entry whose Primary Volume ID 2142 is equal to the ID of the volume identified in the flow at 1001.

The flow then proceeds to 1112, wherein the Command Processing Program 1000 deletes the remote replication pair determined in the flow at 1111 by deleting the corresponding entry in Remote Replication Pair Management Table 214.

The storage pool expansion request may include the capacity by which the storage pool is to be expanded. In this case, in the flow at 1103, the Command Processing Program 1000 selects a Storage Device 22A that has a capacity that is greater than the specified capacity. Instead of selecting a single Storage Device 22A, the Command Processing Program 1000 may select multiple Storage Devices 22A that have an aggregate capacity that is greater than the specified capacity. In this case, in the flow at 1104, Command Processing Program 1000 adds all of the Storage Devices 22A selected in the flow at 1103 to the target storage pool. A storage pool expansion request may specify the kind of Storage Device 22A (e.g., SATA HDD, SAS HDD or SSD) to be used in the expansion. In this case, in the flow at 1103, the Command Processing Program 1000 selects the specified kind of Storage Device 22A.

A storage pool contraction request may include the capacity by which the storage pool is to be contracted. In this case, in the flow at 1106, the Command Processing Program 1000 selects a Storage Device 22A that has a capacity that is greater than the specified capacity. Instead of selecting a single Storage Device 22A, the Command Processing Program 1000 may select multiple Storage Devices 22A that have an aggregate capacity that is greater than the specified capacity. In this case, in the flow at 1107, the Command Processing Program 1000 migrates the data stored on all of the Storage Devices 22A selected in the flow at 1106 to different Storage Devices 22A that are being used by the target storage pool. Then in the flow of 1108, Command Processing Program 1000 removes all of the Storage Devices 22A selected in the flow at 1106 from the target storage pool.

In the flow at 1109 and 1110, the Command Processing Program 1000 may create a local replication pair instead of creating a remote replication pair. In this case, in the flow of 1109, the Command Processing Program 1000 selects a volume to be used as the destination of the local replication by selecting an unused volume from Volume Management Table 212. In the flow of 1110, the Command Processing Program 1000 creates a local replication pair between the volume determined in the flow at 1001 and the volume selected in the flow of 1109 by adding an entry to Local Replication Pair Management Table 215.

In the flow at 1111 and 1112, the Command Processing Program 1000 may delete a local replication pair instead of creating a remote replication pair. In this case, in the flow of 1111, Command Processing Program 1000 determines the target local replication pair by looking up Local Replication Pair Management Table 215. In the flow at 1112, the Command Processing Program 1000 deletes the local replication pair determined in the flow at 1111 by deleting the corresponding entry in Local Replication Management Table 215.

In a second example implementation, the application designates a high-level objective regarding a storage infrastructure change, and a storage system selects the optimal storage function from among the implemented storage functions to meet the objective. The physical configuration of the system is the same as in the first example implementation. The differences in logical configuration of the system and how the system is controlled are described below.

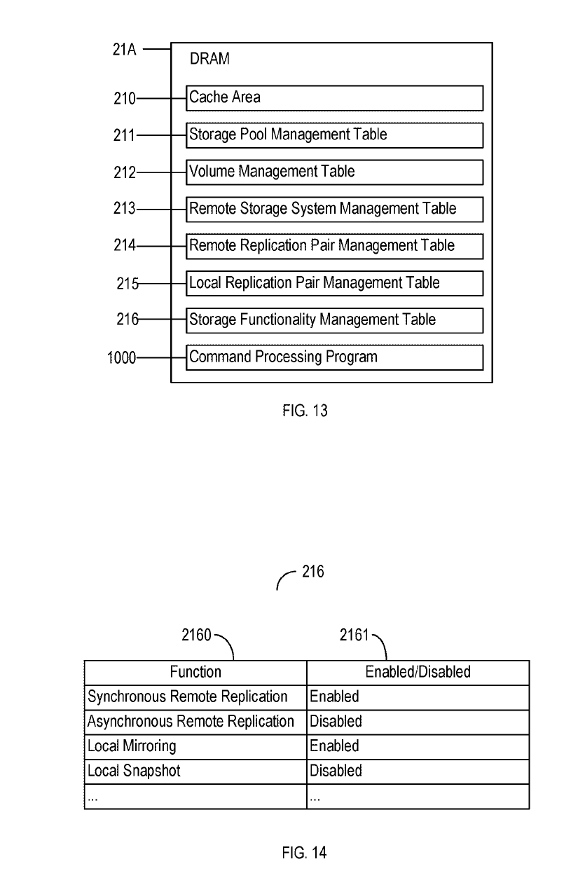

FIG. 13 illustrates a logical layout of the DRAM of a primary storage system, in accordance with an example implementation. Specifically. FIG. 13 illustrates an example logical layout of DRAM 21A in the second example implementation. The layout is essentially the same as described in the first example implementation, but DRAM 21A contains an additional table, Storage Functionality Management Table 216. DRAM 21A contains multiple Remote Replication Pair Management Tables 214, each corresponding to a remote replication function implemented by Primary Storage System 2A.

FIG. 14 illustrates a logical layout of a storage functionality management table, in accordance with an example implementation. Specifically, FIG. 14 shows the logical layout of the Storage Functionality Management Table 216. Storage Functionality Management Table 216 is used to manage which implemented storage functions are enabled. A possible reason for an implemented storage function to be disabled is if the license key is not installed. Storage Functionality Management Table 216 can include multiple entries, each corresponding to a storage function. Each entry can include Function 2160 and Enabled/Disabled 2161.

Function 2160 is used to identify the storage function implemented by Primary Storage System 2A. Example values of Function 2160 can include “Synchronous Remote Replication”, “Asynchronous Remote Replication”, “Local Mirroring” and “Local Snapshot”. “Synchronous Remote Replication” corresponds to a storage function that synchronously replicates data from a volume of Primary Storage System 2A to a volume of Secondary Storage System 2B. Synchronous replication indicates that the replication occurs at the time of write request processing. “Asynchronous Remote Replication” corresponds to a storage function that asynchronously replicates data from a volume of Primary Storage System 2A to a volume of Secondary Storage System 2B. Asynchronous replication indicates that the replication occurs after write request processing. “Local Mirroring” corresponds to a storage function that performs a full copy between two volumes of Primary Storage System 2A. “Local Snapshot” corresponds to a storage function that creates one or more snapshots of a source volume of Primary Storage System 2A. Each snapshot provides the data that was stored in the source volume when the snapshot was created. If some or all of the data provided by the source volume and one of the snapshots is the same, that data may be shared by the source volume and the snapshot and therefore only needs to be stored once in Storage Device 22A.

Enabled/Disabled 2161 is used to determine whether the storage function is enabled or disabled. Example values of Enabled/Disabled 2161 are “Enabled” and “Disabled”. “Enabled” corresponds to a state in which the function identified by Function 2160 is enabled. “Disabled” corresponds to a state in which the function identified by Function 2160 is disabled.

FIG. 15 illustrates a flow diagram for management request processing, in accordance with an example implementation. Specifically, FIG. 15 shows the flow chart of management request processing in the second example implementation. This flow corresponds to the flow at 1005 in FIG. 11, and is executed instead of the flow in FIG. 12.

In the flow of 1201, the Command Processing Program 1000 determines whether the sub-type of the management request is a disaster recovery enablement request, a disaster recovery disablement request, backup enablement request or a backup disablement request by extracting the operation sub-code from the received command.

For the sub-type of the management request being a disaster recovery enablement request (Disaster Recovery Enablement), the flow proceeds to 1202, wherein the Command Processing Program 1000 selects a remote replication storage function to use to enable disaster recovery. One algorithm that the Command Processing Program 1000 may use to select the remote replication storage function to use is to prioritize synchronous remote replication over asynchronous remote replication. First, the Command Processing Program 1000 looks up Storage Function Management Table 216 and checks if Enabled/Disabled 2161 of the entry whose Function 2160 is equal to “Synchronous Remote Replication” is equal to “Enabled”. If it is, Command Processing Program 1000 selects synchronous remote replication. Otherwise, Command Processing Program 1000 checks if Enabled/Disabled 2161 of the entry whose Function 2160 for “Asynchronous Remote Replication” is equal to “Enabled”. If it is, the Command Processing Program 1000 selects asynchronous remote replication. Otherwise, there is no remote replication storage function that can be used to enable disaster recovery, so Command Processing Program 1000 returns an error code to Host Computer 1.

An alternative algorithm that Command Processing 1000 may use to select the remote replication storage function to use is to prioritize asynchronous remote replication over synchronous remote replication. Yet another alternative algorithm that Command Processing 1000 may use to select the remote replication storage function to use is to select synchronous remote replication if the latency between Storage System 2A and the Storage System 2B acting as the destination of the remote replication is equal to or less than a pre-determined threshold, and to select asynchronous remote replication if the latency is greater than the pre-determined threshold. The value of the latency may be provided by the user or it may be measured by Storage System 2A and the Storage System 2B acting as the destination of the remote replication. The flow proceeds to 1203 which can be implemented in a similar manner as that of the flow at 1109.

At 1204, the Command Processing Program 1000 creates a remote replication pair between the volume determined in the flow at 1001 and the volume selected in the flow at 1203 by adding a new entry to the Remote Replication Pair Management Table 214 corresponding to the remote replication storage function selected in the flow at 1202.

For the sub-type of the management request being a disaster recovery disablement request (Disaster Recovery Disablement), the flow proceeds to 1205 wherein the Command Processing Program 1000 determines the target remote replication pair by looking up Remote Replication Pair Management Table 214 and locating the entry whose Primary Volume ID 2142 is equal to the ID of the volume identified in the flow at 1001. The flow proceeds to 1206, wherein the Command Processing Program 1000 deletes the remote replication pair determined in the flow at 1205 by deleting the corresponding entry in Remote Replication Pair Management Table 214.

For the sub-type of the management request being a backup enablement request (Backup Enablement), the flow proceeds to 1207 wherein the Command Processing Program 1000 selects a local replication storage function to use to enable backup. One algorithm that Command Program 1000 may use to select the local replication storage function to use is to prioritize snapshot over full copy. First, the Command Processing Program 1000 looks up Storage Function Management Table 216 and checks if Enabled/Disabled 2161 of the entry whose Function 2160 is equal to “Local Snapshot” is equal to “Enabled”. If it is, the Command Processing Program 1000 selects the snapshot. Otherwise, the Command Processing Program 1000 checks if Enabled/Disabled 2161 of the entry whose Function 2160 is equal to “Local Mirroring” is equal to “Enabled”. If it is, the Command Processing Program 1000 selects to fully copy. Otherwise, there is no local replication storage function that can be used to enable backup, so Command Processing Program 1000 returns an error code to Host Computer 1. An alternative algorithm that Command Processing 1000 may use to select the local replication storage function to use is to prioritize full copy over snapshot.

At 1208, the Command Processing Program 1000 selects a volume to be used as the destination of local replication by selecting an unused volume of Primary Storage System 2A that has the same or larger capacity as the volume determined in the flow at 1001. Alternatively, the Command Processing Program 1000 may create a new volume that has the same capacity as the volume determined in the flow at 1001, and select the new volume. At 1209, the Command Processing Program 1000 creates a local replication pair between the volume determined in the flow at 1001 and the volume selected in the flow at 1208 by adding a new entry to the Local Replication Pair Management Table 215 corresponding to the local replication storage function selected in the flow at 1207.

For the sub-type of the management request being a backup disablement request (Backup Disablement), the flow proceeds to 1210, wherein the Command Processing Program 1000 determines the target local replication pair by looking up Local Replication Pair Management Table 215 and locating the entry whose Primary Volume ID 2151 is equal to the ID of the volume identified in the flow at 1001. At 1211, the Command Processing Program 1000 deletes the remote replication pair determined in the flow at 1210 by deleting the corresponding entry in Local Replication Pair Management Table 215.

In a third example implementation, the application designates an objective along with a storage management request, and a storage system determines if the objective can be met by the request. The physical configuration of the system can be the same as the first example implementation. The differences in logical configuration of the system and how the system is controlled are described below.

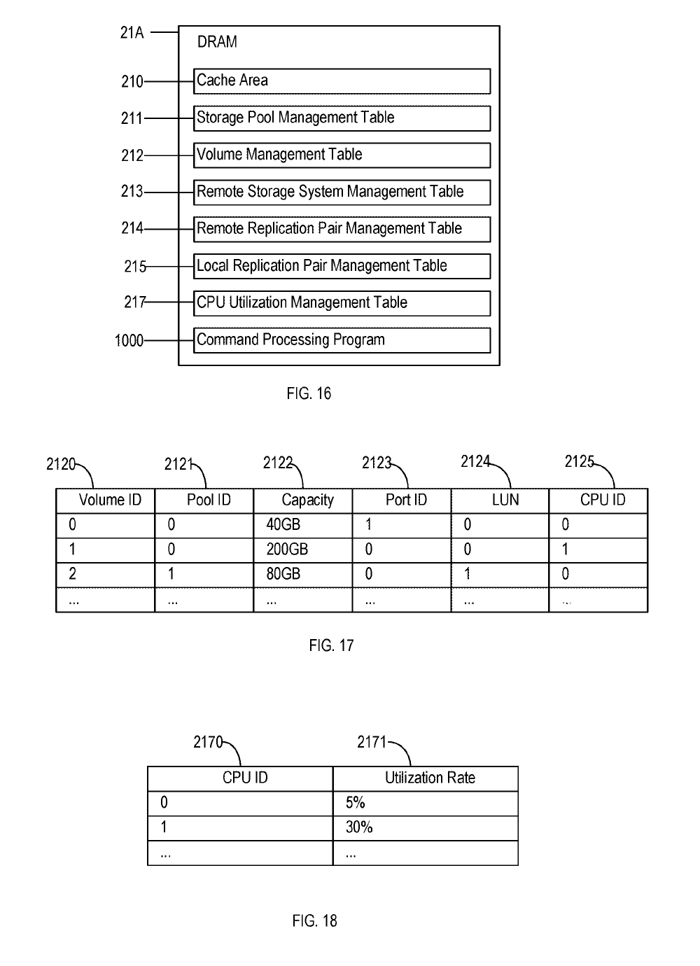

FIG. 16 illustrates a logical layout of DRAM for a primary storage system, in accordance with an example implementation. Specifically, FIG. 16 illustrates the logical layout of DRAM 21A in a third example implementation. The layout is essentially the same as in the first example implementation, however DRAM 21A contains an additional CPU Utilization Table 217.

FIG. 17 illustrates a logical layout of a volume management table 212, in accordance with an example implementation. Specifically, FIG. 17 shows the logical layout of Volume Management Table 212 for the third example implementation. The layout is essentially the same as in the first example implementation, however each entry in Volume Management Table 212 contains an additional field CPU ID 2125. CPU ID 2125 is used to identify the CPU 20A responsible for processing I/O requests for the volume identified by Volume 2120.

FIG. 18 illustrates a logical layout of a CPU Utilization Management Table, in accordance with an example implementation. Specifically, FIG. 18 illustrates the logical layout of CPU Utilization Management Table 217, which is used to manage the utilization of the CPUs 20A in Primary Storage System 2A. CPU Utilization Management Table 217 can include multiple entries, each of which corresponds to a CPU 20A. Each entry can include CPU ID 2170 and Utilization Rate 2171. CPU ID 2170 is used to identify a CPU 20A internally within Primary Storage System 2A. Example values of CPU ID 2170 can include “0” and “1”. Utilization Rate 2171 is the utilization rate of the CPU 20A identified by CPU ID 2170. Example values of Utilization Rate 2171 can include “5%” and “30%”.

FIG. 19 illustrates a flow diagram for management request processing, in accordance with an example implementation. Specifically, FIG. 19 shows the flow chart of management request processing in accordance with the third example implementation. The flow corresponds to the flow at 1005 in FIG. 11, and is executed instead of the flow in FIG. 12. The management request includes an objective code that specifies the objective of the management request.

At 1301, the Command Processing Program 1000 determines whether the sub-type of the management request is a storage pool expansion request or an inter-pool migration request by extracting the operation sub-code from the received command.

For the sub-type of the management request being a storage pool expansion request (Pool Expansion), the flow proceeds to 1302, wherein the Command Processing Program 1000 determines whether the objective of expanding the storage pool is to increase the capacity of the storage pool to which the volume determined in the flow at 1001 belongs or to increase the performance of the volume by extracting the objective code from the received command. If the objective is to increase the capacity (Increase Capacity), then the flow proceeds to 1303, 1304 and 1305, which execute the same processes as the flow at 1102, 1103 and 1104 respectively. If the objective is to increase performance (Increase Performance), then the flow proceeds to 1306, wherein the Command Processing Program 1000 determines whether or not the objective of increasing the performance of the volume determined in the flow at 1001 can be met by expanding the storage pool to which the volume belongs.

In order to make this determination, Command Processing Program 1000 checks whether CPU 20A is the bottleneck or not. Command Processing Program 1000 looks up Volume Management Table 212 and locates the entry where Volume ID 2120 is equal to the ID of the volume determined from the flow at 1001. Command Processing Program 1000 then looks up CPU Utilization Management Table 217 and locates the entry where CPU ID 2170 is equal to CPU ID 2125 of the entry located in Volume Management Table 212. If Utilization Rate 2171 of the entry located in CPU Utilization Management Table 217 is above a certain threshold, for example 70%, then Command Processing Program 1000 determines that CPU 20A is the bottleneck and that the objective cannot be met. Otherwise, Command Processing Program 1000 determines that the objective can be met.

For the objective of increasing performance not being able to be met (No), the flow proceeds to 1307 wherein the Command Processing Program 1000 returns an error code to Host Computer 1, indicating that the specified objective will not be met by expanding the storage pool. Otherwise (Yes) the flow proceeds to 1303.

For the sub-type of the management request being an inter-pool migration request (Inter-Pool Migration), then the flow proceeds to 1308 wherein the Command Processing Program 1000 determines whether the objective of migrating the volume determined in Step 1001 to a different storage pool is to free capacity from the storage pool or to increase the performance of the volume. If the objective is to free capacity (Free Capacity), then the flow proceeds to 1309, wherein the Command Processing Program 1000 determines the storage pool that the volume determined in the flow 1001 is using. To make this determination, the Command Processing Program 1000 references Volume Management Table 212 and locates the entry whose Volume ID 2120 is equal to the ID of the volume. Pool ID 2121 of the located entry is the ID of the storage pool that the volume is using, and this storage pool is the source of the inter-pool migration. At 1310, the Command Processing Program 1000 selects from the storage pools in Primary Storage System 2A a storage pool that is different from the source storage pool determined in the flow of 1309. The selected storage pool is the destination of the inter-pool migration. One algorithm that Command Processing Program 1000 may use to select a destination storage pool is to select the storage pool that is being used by the least number of volumes. The Command Processing Program 1000 determines the number of volumes that are using each storage pool by counting the number of entries that have the ID of the storage pool in Pool ID 2121 of Volume Management Table 212. At 1311, the Command Processing Program 1000 migrates the data of the volume determined in Step 1001 from the source storage pool determined in the flow at 1309 to the destination storage pool determined in the flow at 1310. Command Processing Program 1000 then changes Pool ID 2121 of the entry located in the flow at 1309 from the ID of the source storage pool to the ID of the target storage pool.

If the objective is to Increase Performance (Increase Performance), the flow proceeds to 1312, wherein the Command Processing Program 1000 determines whether or not the objective of increasing the performance of the volume determined in the flow at 1001 can be met by migrating the volume to a different storage pool. To make this determination, the Command Processing Program 1000 checks whether CPU 20A is the bottleneck or not. The Command Processing Program 1000 looks up Volume Management Table 212 and locates the entry where Volume ID 2120 is equal to the ID of the volume determined in the flow at 1001. Command Processing Program 1000 then looks up CPU Utilization Management Table 217 and locates the entry whose CPU ID 2170 is equal to CPU ID 2125 of the entry located in Volume Management Table 212. If Utilization Rate 2171 of the entry located in CPU Utilization Management Table 217 is above a certain threshold, for example 70%, then Command Processing Program 1000 determines that CPU 20A is the bottleneck and that the objective cannot be met. Otherwise, Command Processing Program 1000 determines that the objective can be met.

If the objective for increasing performance can be met (Yes), then the flow proceeds to 1309. Otherwise (No), then the flow proceeds to 1313, wherein the Command Processing Program 1000 returns an error code to Host Computer 1, indicating that the specified objective will not be met by migrating the volume.

Some portions of the detailed description are presented in terms of algorithms and symbolic representations of operations within a computer. These algorithmic descriptions and symbolic representations are the means used by those skilled in the data processing arts to convey the essence of their innovations to others skilled in the art. An algorithm is a series of defined steps leading to a desired end state or result. In example implementations, the steps carried out require physical manipulations of tangible quantities for achieving a tangible result.

Unless specifically stated otherwise, as apparent from the discussion, it is appreciated that throughout the description, discussions utilizing terms such as “processing,” “computing,” “calculating,” “determining,” “displaying,” or the like, can include the actions and processes of a computer system or other information processing device that manipulates and transforms data represented as physical (electronic) quantities within the computer system's registers and memories into other data similarly represented as physical quantities within the computer system's memories or registers or other information storage, transmission or display devices.

Example implementations may also relate to an apparatus for performing the operations herein. This apparatus may be specially constructed for the required purposes, or it may include one or more general-purpose computers selectively activated or reconfigured by one or more computer programs. Such computer programs may be stored in a computer readable medium, such as a computer-readable storage medium or a computer-readable signal medium. A computer-readable storage medium may involve tangible mediums such as, but not limited to optical disks, magnetic disks, read-only memories, random access memories, solid state devices and drives, or any other types of tangible or non-transitory media suitable for storing electronic information. A computer readable signal medium may include mediums such as carrier waves. The algorithms and displays presented herein are not inherently related to any particular computer or other apparatus. Computer programs can involve pure software implementations that involve instructions that perform the operations of the desired implementation.

Various general-purpose systems may be used with programs and modules in accordance with the examples herein, or it may prove convenient to construct a more specialized apparatus to perform desired method steps. In addition, the example implementations are not described with reference to any particular programming language. It will be appreciated that a variety of programming languages may be used to implement the teachings of the example implementations as described herein. The instructions of the programming language(s) may be executed by one or more processing devices, e.g., central processing units (CPUs), processors, or controllers.

As is known in the art, the operations described above can be performed by hardware, software, or some combination of software and hardware. Various aspects of the example implementations may be implemented using circuits and logic devices (hardware), while other aspects may be implemented using instructions stored on a machine-readable medium (software), which if executed by a processor, would cause the processor to perform a method to carry out implementations of the present application. Further, some example implementations of the present application may be performed solely in hardware, whereas other example implementations may be performed solely in software. Moreover, the various functions described can be performed in a single unit, or can be spread across a number of components in any number of ways. When performed by software, the methods may be executed by a processor, such as a general purpose computer, based on instructions stored on a computer-readable medium. If desired, the instructions can be stored on the medium in a compressed and/or encrypted format.

Moreover, other implementations of the present application will be apparent to those skilled in the art from consideration of the specification and practice of the teachings of the present application. Various aspects and/or components of the described example implementations may be used singly or in any combination. It is intended that the specification and example implementations be considered as examples only, with the true scope and spirit of the present application being indicated by the following claims.

What is claimed is:

1. A storage system configured to process a command from an application of a host computer directed to a read operation, a write operation or a management operation, the storage system comprising:
a processor, configured to, for the command being directed to the management operation:
determine a first resource allocated to the application;
select a second resource managed by the storage system that is not allocated to the application;
allocate the second resource to the application; and
execute the management operation by using the first resource and the second resource.

2. The storage system of claim 1, wherein for the management operation being directed to a storage pool expansion request, the processor is configured to:
determine the first resource allocated to the application through a determination of a target storage pool that is allocated to the application;
select the second resource through a selection of a storage device that is not allocated to the target storage pool; and
execute the management operation through an allocation of the storage device to the target storage pool.

3. The storage system of claim 2, wherein for the management operation being directed to an objective to increase performance, the processor is configured to process the command only for a determination that the objective to increase performance is met.

4. The storage system of claim 1, wherein for the management operation being directed to a replication pair creation request, the processor is configured to:
determine the first resource allocated to the application through a determination of a first volume that is allocated to the application;
select the second resource through a selection of a second volume that is not allocated to the application; and
execute the management operation through a creation of a replication pair between the first volume and the second volume.

5. The storage system of claim 1, wherein for the management operation being directed to a disaster recovery enablement request, the processor is configured to:
select a remote replication storage function;
determine the first resource allocated to the application through a determination of a first volume that is allocated to the application;
select the second resource through a selection of a second volume that is not allocated to the application, wherein the second volume is located remotely from the storage system; and
execute the management operation through a creation of a replication pair between the first volume and the second volume and through a provision of the remote replication storage function to the application.

6. The storage system of claim 1, wherein for the management operation being directed to a backup enablement request, the processor is configured to:
select a local replication storage function;
determine the first resource allocated to the application through a determination of a first volume that is allocated to the application;
select the second resource through a selection of a second volume that is not allocated to the application and that is provisioned locally within the storage system; and
execute the management operation through a creation of a replication pair between the first volume and the second volume and through a provision of the local replication storage function to the application.

7. The storage system of claim 1, wherein for the management operation being directed to an inter-pool migration, the processor is configured to:
determine the first resource allocated to the application through a determination of a first volume that is allocated to the application;
select the second resource through a selection of a second volume that is not allocated to the application; and
execute the management operation through a migration of the first volume to the second volume.

8. A non-transitory computer readable medium storing instructions for executing a process for a storage system configured to process a command from an application of a host computer directed to a read operation, a write operation or a management operation, the instructions comprising:
for the command being directed to the management operation:
determining a first resource allocated to the application;
selecting a second resource managed by the storage system that is not allocated to the application;
allocating the second resource to the application; and
executing the management operation by using the first resource and the second resource.

9. The non-transitory computer readable medium of claim 8, wherein for the management operation being directed to a storage pool expansion request, the instructions further comprise:
determining the first resource allocated to the application through a determination of a target storage pool that is allocated to the application;
selecting the second resource through a selection of a storage device that is not allocated to the target storage pool; and
executing the management operation through an allocation of the storage device to the target storage pool.

10. The non-transitory computer readable medium of claim 9, wherein for the management operation being directed to an objective to increase performance, the instructions further comprise processing the command only for a determination that the objective to increase performance is met.

11. The non-transitory computer readable medium of claim 8, wherein for the management operation being directed to a replication pair creation request, the instructions further comprise:
determining the first resource allocated to the application through a determination of a first volume that is allocated to the application;
selecting the second resource through a selection of a second volume that is not allocated to the application; and
executing the management operation through a creation of a replication pair between the first volume and the second volume.

12. The non-transitory computer readable medium of claim 8, wherein for the management operation being directed to a disaster recovery enablement request, the instructions further comprise:
selecting a remote replication storage function;
determining the first resource allocated to the application through a determination of a first volume that is allocated to the application;
selecting the second resource through a selection of a second volume that is not allocated to the application, wherein the second volume is located remotely from the storage system; and
executing the management operation through a creation of a replication pair between the first volume and the second volume and through a provision of the remote replication storage function to the application.

13. The non-transitory computer readable medium of claim 8, wherein for the management operation being directed to a backup enablement request, the instructions further comprise:
selecting a local replication storage function;
determining the first resource allocated to the application through a determination of a first volume that is allocated to the application;
selecting the second resource through a selection of a second volume that is not allocated to the application and that is provisioned locally within the storage system; and
executing the management operation through a creation of a replication pair between the first volume and the second volume and through a provision of the local replication storage function to the application.

14. The non-transitory computer readable medium of claim 8, wherein for the management operation being directed to an inter-pool migration, the instructions further comprise:
determining the first resource allocated to the application through a determination of a first volume that is allocated to the application;
selecting the second resource through a selection of a second volume that is not allocated to the application; and
executing the management operation through a migration of the first volume to the second volume.

15. A method for a storage system configured to process a command from an application of a host computer directed to a read operation, a write operation or a management operation, the method comprising:
for the command being directed to the management operation:
determining a first resource allocated to the application;
selecting a second resource managed by the storage system that is not allocated to the application;
allocating the second resource to the application; and
executing the management operation by using the first resource and the second resource.
